(19) United States
(12) Patent Application Publication
(10) Pub. No.: US 2007/0023570 A1
(43) Pub. Date: Feb. 1, 2007

(54) System and method for remote control of interdiction aircraft

(76) Inventor: Charles W. Bernard, West Columbia, TX (US)

Correspondence Address: FULBRIGHT & JAWORSKI;MARKET SQUARE, 801 PENNSLYVANIA, N.W., WASHINGTON, DC, 200042604, US

(21) Appl. No.: 11/192,171

(22) Filed: Jul. 29, 2005

Related U.S. Application Data
(60) Provisional application No. 60/592,071, filed on Jul. 29, 2004.

(51) Int. Cl. B64C 13/00

(52) U.S. Cl. 244/75.1

(57) ABSTRACT

An aircraft attack interdiction system using an unmanned interdiction aircraft piloted using a remote control system. In-flight refueling system, weapons launcher systems and intelligence gathering equipment are mounted on the interdiction aircraft. A remote flight control operator to remotely fly the interdiction aircraft can be based on a remote flight control commander aircraft that can be flown at safe distances from targets that are attacked by the interdiction aircraft.

### CROSS-REFERENCE TO RELATED APPLICATIONS

This Application claims the benefit of Provisional Application Ser. No. 60/592,071 filed on Jul. 29, 2004, and, further, all disclosures made for Provisional Application Ser. No. 60/592,071 are incorporated herein by reference.

### BACKGROUND OF THE INVENTION

1. Field of Invention

The invention relates to systems and methods for operations to be conducted by remotely flown unmanned aircraft. More particularly, the present invention relates to systems and methods for remote control of intelligence gathering and military combat aircraft, including remote control for refueling the unmanned aircraft.

2. Background of the Related Art

The history of powered flight began in 1903 with the Wright brothers first flight of an airplane in North Carolina. Within only a few years, aircraft were sufficiently developed so that they were used to drop bombs on ground targets and also strafe ground targets with machine-gun fire. During this same period, efforts were being made to defend ground based installations and operations from air attacks. These efforts centered on shooting projectiles, mostly rifles and machine-guns, at attacking aircraft. The most effective defense, at this early stage, was provided by aircraft firing machine-guns at attacking aircraft as opposed to gun fire from ground locations. By the end of World War II ground located anti-aircraft guns were beginning to use radar for fire control and were firing projectiles with specially designed fuzes, these modifications were improving anti-aircraft gunfire effectiveness in hitting attacking aircraft, but still these ground located anti-aircraft guns were not adequately effective so as to substantially prevent successful aircraft interdiction attacks.

Beginning in the 1950's and especially into the 1960's, a substantial change in ground defense effectiveness from aircraft interdiction missions was realized. The change was brought about by using rocket propelled warheads that were combined with guidance technologies to provide both short and long-range surface-to-air missile defense systems. Such missile systems were combined with radar controlled anti-aircraft guns to provide very effective layered defenses from interdiction aircraft attacks for ground based installation and operations. The development and deployments of effective air defenses have made aircraft interdiction missions expensive in terms of both lost air crew lives and destroyed aircraft.

Technologies such as Electronic Countermeasures (ECM), Anti-Radar (radiation) Missiles (ARMs), Electronic Warfare (early warning) (EW), and Electronic Intelligence (ELINT) have been developed, deployed and used to suppress lethal ground based air defenses. Most recently these technologies have been augmented with the introduction and use of low radar cross section stealth aircraft. These technologies have met with measures of success, but they also have come at both high costs in terms of financial investments and time for development and deployment because of their sophistication.

Requirements for performing effective aircraft interdiction missions have not waned despite the improvements in anti-aircraft defenses. The increased risks of loss of life and aircraft damage, therefore, have increased potential costs for performing aircraft interdiction missions.

The beginning of the 21^{st} century finds a world with only one superpower nation, which in certain terms increases prospects for peace. However, several regions of the world are very unstable in terms of political or religious beliefs and though these regions are not the most developed they have become sources of commando style military threats and even more difficult to predict terrorist actions. This situation portends a continuing trend in attrition type military actions as have occurred for about the last decade. These attrition type military actions do not occur between opposing modern sophisticated military forces with expensive equipment fighting each other, but instead often have paramilitary cells or units undertaking military or terrorist style operations against military or civilian targets. The new threat often is characterized by forces composed of non-uniformed individuals or small unit forces. Besides other substantially portable weapons, they can carry shoulder-fired anti-aircraft weapons, e.g. the SA-7 first introduced by the former Soviet Union. These unconventional military units in being small and quasi-independent in operations are capable of significant mobility, and often are effectively protected from being attacked by ground forces because of their mobility that mandates opposing forces to have to search large areas for small units. An effective attack mechanism that can be brought to bear against such units is a gun, or rocket and gun, equipped interdiction aircraft. However, because the units to be attacked are small and can conceal themselves easily and for long periods of times before they reveal themselves, the interdiction aircraft often also have to remain in suspect areas for long periods of time in order to observe the unit target to be attacked. Further, since even small units can be equipped with effective anti-aircraft weapons, such as shoulder fired missiles, an ever increasing possibility of loss of lives for interdiction aircraft crews must be addressed.

### BRIEF SUMMARY OF THE INVENTION

The present invention overcomes prior limitations by providing a system and method for remote control of unmanned interdiction (UI) aircraft from a remote control location. This remote control operation of UI aircraft removes all personnel from the interdiction aircraft, and, thereby, eliminates any possibility of a fatality in the event the UI aircraft is shot down or for some other reason it is damaged or destroyed.

As an aspect of the invention a remote control command (RCC) aircraft would be flown by a crew to a region of operations where it could fly at safe distances and altitudes for long periods of time. This RCC aircraft could tow a UI aircraft or multiple UI aircraft into the operation area, or using remote control systems on board could direct flight of UI aircraft into the operation area. When a target is identified or confirmed, a remote control operator can fly a designated UI aircraft to the target area to perform an attack. Alternatively, when a potential target area is identified, a remote control operator can fly one or more UI aircraft to the designated area to perform on-site surveillance and to be in position to attack any identified and confirmed specific targets.

The invention also addresses the requirement for having to maintain aircraft on-station for sustained periods of time. This sustained aircraft on-station time requirement is addressed by selecting a RCC aircraft type with efficient engines and of sufficient size so that the aircraft can remain on-station for long periods at safe distances and altitudes from potential threat areas. Further, the RCC aircraft type can be equipped with in-flight refueling capability to thereby additionally extend on-station time. These RCC aircraft capabilities are complimented by appropriate selection and equipping of UI aircraft types with in-flight refueling capability. The UI aircraft type is in no way of a comparable size to the RCC aircraft, but engines used to power the UI aircraft types can be selected to use the same type jet fuel as used by the selected RCC aircraft. Therefore, both aircraft types can be refueled from a common tanker aircraft, or the RCC aircraft can be equipped to provide in-flight refueling for UI aircraft in order to maintain them on-station for long periods of time. In-flight refueling of UI aircraft is performed by utilizing the remote control of UI aircraft provided from the RCC aircraft.

An alternative aspect of the invention provides for remote flight control of UI aircraft being performed from a location or locations other than a RCC aircraft. For example, the location can be selected to be satellite based, ground based, ship based, or even submarine based. For non-air based locations, a satellite communications link can be used. For example, a ground based station can use a satellite communications link to remotely control flight of UI aircraft. Again, extended on-station times for UI aircraft can be accomplished through in-flight refueling.

A further mission accomplishable by the invention is rescue. If there is a small on ground friendly unit or a downed pilot stranded in a remote location, the RCC aircraft can direct the UI aircraft to the location to provide fire cover until a rescue team arrives, or the RCC can land the UI aircraft on an open area so that friendly forces or the downed pilot can get on board the aircraft that then can be flown out of the area to a safe location for landing.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It also should be realized by those skilled in the art that such equivalent constructions do not depart from the spirit and scope of the invention as set forth in the appended claims. The novel features which are believed to be characteristic of the invention, both as to its organization and method of operation, together with further objects and advantages, will be better understood from the following description when considered in connection with the accompanying figures. It is to be expressly understood, however, that each of the figures is provided for the purposes of illustration and description only and is not intended as a definition of the limits of the present invention.

### BRIEF DESCRIPTION OF THE DRAWINGS

The invention will be described in detail with reference to the following drawings, in which like reference numerals refer to like elements, and wherein:

FIG. 1 is a schematic diagram showing a configuration for one aspect of the invention;

FIG. 2 is a schematic diagram showing a configuration for another aspect of the invention;

FIG. 3 is a schematic diagram showing a configuration for a further aspect of the invention;

FIG. 4 is a schematic diagram showing an operational configuration for an aspect of the invention;

FIG. 5 is a schematic diagram showing in-flight refueling of unmanned interdiction aircraft from a remote control command aircraft; and,

FIG. 6 is a block diagram for unmanned interdiction aircraft modifications.

### DETAILED DESCRIPTION OF THE INVENTION

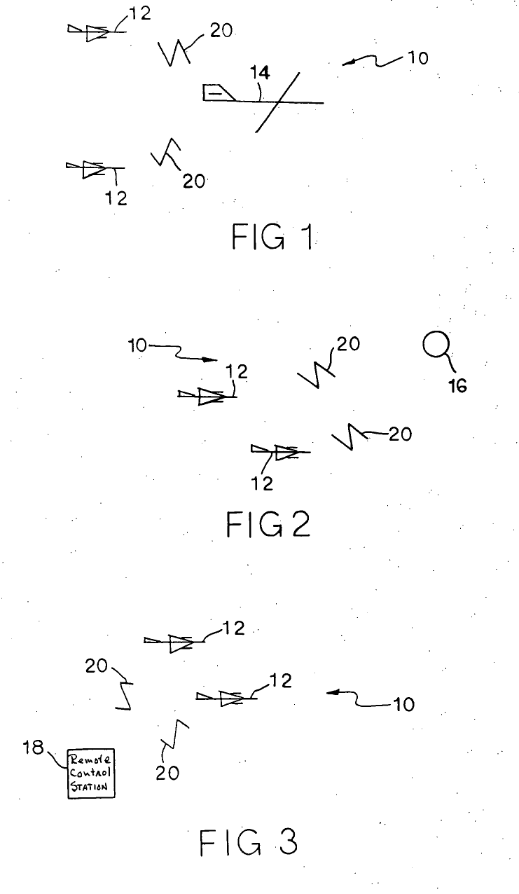

FIGS. 1, 2 and 3 show alternative component locations for an unmanned interdiction aircraft system embodying the invention. The unmanned interdiction aircraft system shown in FIGS. 1, 2 and 3 that embodies the invention is designated with the general reference number 10. One or more unmanned interdiction (UI) aircraft 12 can be operated at any time according to system 10 of the present invention. The system 10 shown in FIG. 1 includes UI aircraft 12 and a remote control command (RCC) aircraft 14. Whereas, FIG. 2 shows multiple UI aircraft 12 and a remote control command satellite 16 usable for controlling UI aircraft 12. FIG. 3 shows multiple UI aircraft 12 and a ground or ship based remote control station 18 that also is usable for controlling UI aircraft 12. For purposes of description here, a RCC aircraft 14 type system as shown in FIG. 1 is described. However, modification to alternative embodiments such as shown in FIGS. 2 and 3 will be apparent to those of ordinary skill in this art.

Multiple aircraft types can be selected for the RCC aircraft 14. Selections can be made based on specific mission requirements and aircraft specifications. The selected aircraft should be of sufficient size as to be able to accommodate pilots and other crew members, such as electronic systems operators. Further, the aircraft should be capable of carrying sufficient quantities of fuel so as to be able to fly long missions with extended periods of time on-station, and, in fact, the aircraft should be capable of in-flight refueling both for taking on fuel and for refueling other aircraft. A capable aircraft type that can meet these requirements is the C-130. This aircraft, configured as a gunship, the AC-130, has successfully performed Persistent Tactical Interdiction Operation (PTIO) missions for decades, and is an appropriate aircraft to be a RCC aircraft 14 for system 10 of the present invention. A PTIO mission can include being assigned responsibility for conducting an interdiction mission deep into hostile territory against an enemy weapon of mass destruction that is hidden in a cave or other difficult to find hiding place and that can be moved out of the hiding place to a launch position. This type of target only may be vulnerable for a short time; consequently, it only can be confirmed and destroyed using an aircraft that can be persistently maintained on-station near the suspected target location deep in hostile territory. The AC-130 aircraft is capable of performing such PTIO missions. However, when performing such missions, the aircraft must approach a confirmed target location within effective ranges of its on-board weapons in order to effectively fire weapons at the target and confirm destruction. When the AC-130 approaches high value target areas to fire weapons, it is exposed to possible anti-aircraft gunfire and anti-aircraft missile firings. If the AC-130 is destroyed the loss of life could be as high as fourteen (14) or more crew members. This invention overcomes that risk.

With an AC-130 selected to be the RCC aircraft 14, an UI aircraft 12 type aircraft to match an AC-130 RCC aircraft 14 can be a Cessna 208. This aircraft is powered by a Pratt & Whitney PT6 engine, which bums the same fuel as AC-130 engines. Additionally, a Cessna 208 UI aircraft 12 can be modified with a remote flight control system 600 and an in-flight refueling system 601 having an expanded fuel reservoir to enable extended continuous operations. These in-flight refueling capability modifications can include an auto-throttle capability to maintain the UI aircraft 12 at constant speed during in-flight refueling. Other modifications that can be made to a Cessna 208 to provide UI aircraft 12 capabilities include installation of: a secure strategic and tactical bi-directional video/flight data link system 602; attack weapon systems 603 such as rockets, missiles and guns; a Forward Looking Infra-Red (FLIR)/Laser designator system 604 to be used to locate and identify targets using infra-red imagery, and to illuminate targets to be destroyed using laser semi-active guided weapons; Electronic Intelligence (ELINT) systems 605; and electronic protective systems such as ECW 606 and decoy systems. Similarly the AC-130 RCC aircraft 14 is modified to include a complimentary secure strategic and tactical bi-directional video/flight data link system. Video and data signals 20 are exchanged between the RCC aircraft 14 and UI aircraft 12 using the secure strategic and tactical bi-directional video/flight data link systems. These video and data signals 20 are used to provide remote flight control directions from the RCC aircraft 14 using a remote flight controller system. Further, these video and data signals 20 are used to communicate intelligence information to the RCC aircraft 14. The intelligence information having been gathered by UI aircraft 12 using on-board sensors such as ELINT and imaging devices such as FLIR. A record will be kept on the RCC aircraft 14 of the intelligence information provided from the UI aircraft 12. This provided intelligence information can be transmitted to other operational aircraft and other ground and naval forces for use in conducting operations.

Another modification that can be made to a RCC aircraft 12 is to install equipment to receive and transmit Global Positioning System (GPS) information to UI aircraft 12 for maintaining the UI aircraft 12 at on-station locations with respect to the RCC aircraft 14. Such transmitted GPS information also can be used for other purposes. In the instance of maintaining UI aircraft 12 at cruise locations with respect to the RCC aircraft 14, the GPS information transmitted from the RCC aircraft 14 is adjusted to provide the UI aircraft 12 with location information that is displaced from the RCC aircraft 12 and that therefore is a moving location to which the UI aircraft 12 can be flown.

Two aspects of this invention are the protection provided to the RCC aircraft 14 by having it maintained at safe distances from threat areas, and the in-flight refueling capability of the UI aircraft 12.

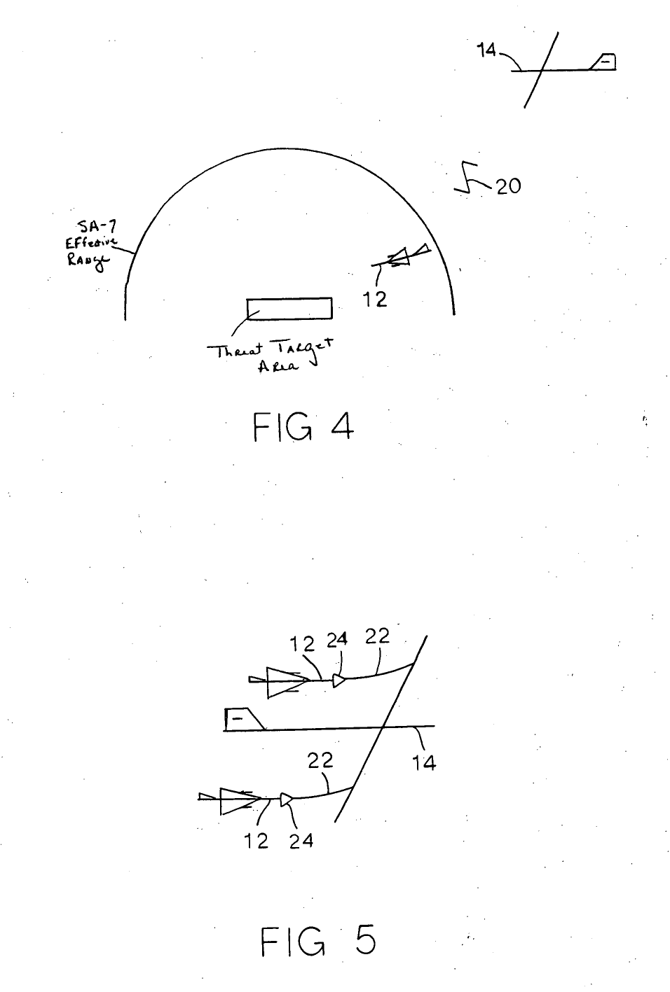

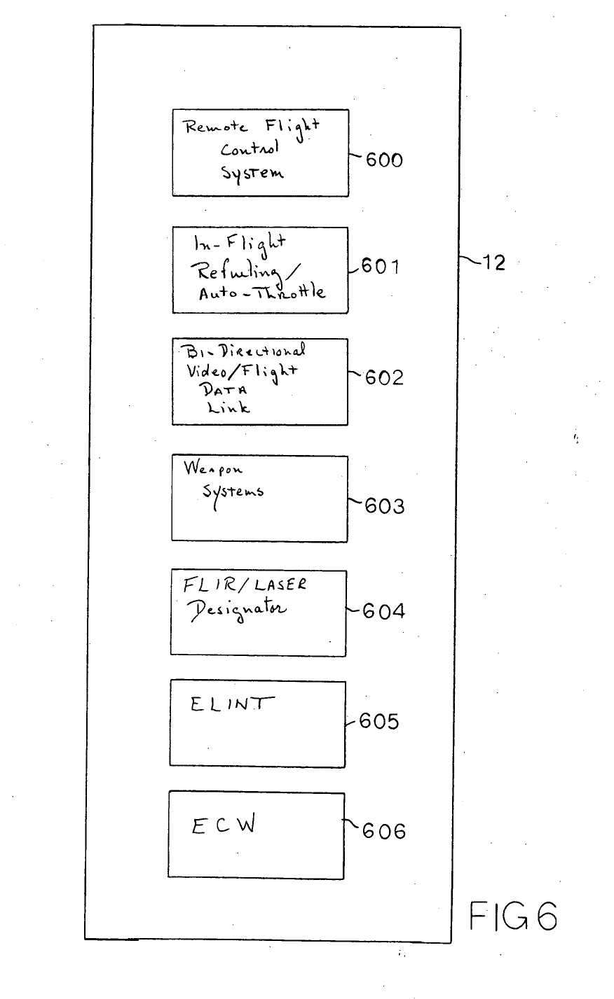

The first of these aspects is illustrated in FIG. 4. In this scenario a threat target area has been identified that is believed to be defended with shoulder fired ground-to-air antiaircraft missiles such as SA-7's. The SA-7 missile has a range of about three (3) miles. Therefore, if an aircraft is ordered to attack the threat target area, and it further is ordered to proceed within three (3) miles of the threat target area location to make the attack, the safest situation would be for the attack aircraft to be an unmanned aircraft. Using the present invention, the RCC aircraft 14 can be stationed a safe distance from the threat target area and an UI aircraft 12 can be remotely flown using signals 20 provided from the RCC aircraft 14 to make the attack, including launching weapons.

The second of the referenced aspects is illustrated in FIG. 5. Here, a RCC aircraft 14 is shown refueling two UI aircraft 12. C-130 aircraft have been modified to be KC-130 aircraft tankers for in-flight refueling of helicopters. The AC-130 RCC aircraft 14 according to the present invention are an aircraft type that typically already have been modified for being able to be in-flight refueled, and these aircraft further can be modified with in-flight refueling capability 22 as shown in FIG. 5. Appropriate remote control sensors and communications links to remotely fly UI aircraft 12 are provided for the invention for in-flight refueling of the UI aircraft 12 from the AC-13 RCC aircraft. For example, RCC aircraft 14 modified to include in-flight refueling capability 22 can provide ballutes 24 at the ends of refueling lines. A ballute 24 at the end of a refueling line is used to stabilize aerodynamics of the combination, and also to provide a target for the UI aircraft 12 that can be used for connection. UI aircraft 12 in-flight refueling probes (not shown) can be flown into the ballutes 24 using remote flight control to make connections for refueling. In operation, a remote flight operator on the RCC aircraft 14 would use the aircraft remote flight controller and imaging equipment, such as television cameras mounted on the UI aircraft 12, to fly the UI aircraft 12 in-flight refueling probe into a ballute 24 to make a connection for refueling. Alternatively, the RCC aircraft 14 can remotely fly UI aircraft 12 for in-flight refueling from a KC-130 tanker or other available tanker aircraft. This in-flight refueling capability 22 from RCC aircraft 14 (such as a modified AC-130) for UI aircraft 12 provides RCC aircraft 14 and UI aircraft 12 with matched on-station time capability to remain in assigned areas to perform missions. In other words, by using in-flight refueling, extended periods of length of time on-station can be maintained independent of different aircraft type fuel consumption requirements for the RCC aircraft 14 and the UI aircraft 12.

Although the present invention and its advantages have been described in detail, it should be understood that various changes, substitutions and alterations can be made herein without departing from the spirit and scope of the invention as defined by the appended claims. Moreover, the scope of the present description is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. An air interdiction system comprising:
at least one interdiction aircraft, said interdiction aircraft having remote flight control means for flying said interdiction aircraft as an unmanned aircraft;
a weapon launcher means disposed on said interdiction aircraft for launching weapons from said interdiction aircraft;
an in-flight refueling means disposed on said interdiction aircraft for receiving fuel into said interdiction aircraft from a tanker aircraft; and,
an aircraft remote flight controller means disposed away from said interdiction aircraft for sending signals to and receiving signals from said remote flight control means to fly said interdiction aircraft as an unmanned aircraft and to launch weapons from said weapon launcher means using signals sent from said aircraft remote flight controller.

2. The air interdiction system according to claim 1, further comprising:
an auto-throttle means disposed on said interdiction aircraft for maintaining said interdiction aircraft at a constant air speed.

3. The air interdiction system according to claim 1, wherein said aircraft remote flight controller means is disposed on a remote flight control command aircraft.

4. The air interdiction system according to claim 1, wherein said aircraft remote flight controller means is disposed on a satellite.

5. The air interdiction system according to claim 1, wherein said aircraft remote flight controller means is disposed at an earth based station.

6. The air interdiction system according to claim 1, further comprising:
an intelligence gathering means disposed on said interdiction aircraft for gathering intelligence information and transmitting the information to said aircraft remote flight controller means.

7. The air interdiction system according to claim 6, wherein said intelligence gathering means includes a FLIR system.

8. The air interdiction system according to claim 1, further comprising:
electronic countermeasure means disposed on said interdiction aircraft for reducing and preventing use of radar signals to track said interdiction aircraft.

9. The air interdiction system according to claim 1, wherein said weapon launcher means includes a rocket launcher.

10. The air interdiction system according to claim 1, wherein said weapon launcher means includes a missile launcher.

11. A method for conducting an air interdiction operation comprising:
providing a remote flight control system to fly an unmanned interdiction aircraft;
providing said interdiction aircraft with an in-flight refueling system for receiving fuel into said interdiction aircraft from a tanker aircraft; and,
providing said interdiction aircraft with a weapon launcher capable of launching weapons in response to signals received from an aircraft remote flight controller system, said aircraft remote flight controller system disposed away from said interdiction aircraft for sending signals to and receiving signals from said remote flight control system to fly said interdiction aircraft as an unmanned aircraft.

12. The method according to claim 11, further comprising:
providing said interdiction aircraft with an auto-throttle system for maintaining said interdiction aircraft at a constant air speed.

13. The method according to claim 11, wherein said aircraft remote flight controller system is disposed on a remote flight control command aircraft.

14. The method according to claim 11 wherein said aircraft remote flight controller system is disposed on a satellite.

15. The method according to claim 11, wherein said aircraft remote flight controller system is disposed at an earth based station.

16. The method according to claim 11, further comprising:
providing said interdiction aircraft with an intelligence gathering system for gathering intelligence information and transmitting the information to said aircraft remote flight controller system.

17. The method according to claim 16, wherein said intelligence gathering system includes a FLIR system.

18. The method according to claim 11, further comprising:
providing said interdiction aircraft with electronic countermeasures system for reducing and preventing use of radar signals to track said interdiction aircraft.

19. The method according to claim 11, wherein said weapon launder includes a rocket launcher.

20. The method according to claim 11 wherein said weapon launcher includes a missile launcher.
